(19) United States
(12) Patent Application Publication
(10) Pub. No.: US 2010/0146879 A1
(43) Pub. Date: Jun. 17, 2010

(54) LAMINATE STAIR TREAD AND METHOD THEREFOR

(75) Inventor: Chee Meng Chin, Burnaby (CA)

Correspondence Address: MAYER & WILLIAMS PC, 251 NORTH AVENUE WEST, 2ND FLOOR, WESTFIELD, NJ, 07090, US

(73) Assignee: DOLLAR TILE DISTRIBUTORS LTD., British Columbia (CA)

(21) Appl. No.: 12/306,197

(22) PCT Filed: Jun. 20, 2007
(86) PCT No.: PCT/CA2007/001089

§ 371 Date: Mar. 1, 2010

Related U.S. Application Data
(60) Provisional application No. 60/814,873, filed on Jun. 20, 2006.

(51) Int. Cl. E04F 11/104; B29C 70/34

(52) U.S. Cl. 52/177; 52/741.2; 156/214

(57) ABSTRACT

The present invention provides a laminate stair tread a core having a top surface and a bottom surface, and opposing read side and front side, the front side being substantially curved, and a laminate layer affixed to the top surface of the core including the curved front side, thereby providing a flat, unobstructed, and seamless surface.

### FIELD OF THE INVENTION

The present invention pertains to stair systems, and more particularly, to laminate stair treads and a method of manufacture and installation therefor.

### BACKGROUND

Due to their ease of installation and wide availability in a plethora of patterns and colors, laminate flooring systems are increasingly gaining popularity with housing contractors, builders, and particularly “do-it-yourself” home renovators. Laminate flooring systems provide an ideal and economical alternative to solid hardwood flooring systems, as they are less expensive to manufacture, and can be installed quickly and inexpensively without requiring a specific level of technical expertise. Moreover, laminate floors exhibit better stain resistance, wear resistance, ease of cleaning, and have a lesser emission of organic compound vapor over other competing flooring products.

Installation of laminate flooring over discontinuous surfaces such as floors in two levels is achieved by laminate stairs. FIG. 1 illustrates a conventional laminate stair system as known in the art. The laminate stair system 110 comprises stringers 112 having tread-supporting sides 113 for supporting laminate stair treads 114, as well as riser-supporting sides 115 to support risers 116. The laminate stair tread 114 is composed of a high density fiberboard (HDF) covered by a layer of laminate. The laminate typically includes sufficient wear resistance to withstand frequent use of the stair system 110 without showing considerable signs of wear and tear or scratching.

The laminate stair treads 114 may be supported by tread subflooring 118 disposed upon the tread-supporting sides 115 of the stringer 112. A layer of vapour barrier 119 can optionally be disposed between the laminate stair treads 114 and the tread subflooring 118 to prevent moisture from penetrating the laminate stair treads 114. Similarly, risers 116 are either directly supported by the riser-supporting sides 115, or affixed to riser subflooring 120 that are attached to the riser-supporting sides 115. The laminate stair tread 114 is complemented by a stair nosing 122 having a curved front side 123 and a rear side 125 that is attached to the front side 127 of the laminate stair tread 114. The stair nosing 122 is typically made of solid hardwood, plastic, metal or similar resilient materials securely attached to the laminate stair tread 114 or the tread subflooring 118 so as to withstand the pressure placed thereupon when a person steps on the stair nosing 122. The stair nosing 122 can protect the edge of the laminate stair treads 114 or the risers 116 from chipping, it can also provide surface continuity between laminate stair treads 114 and risers 116.

The rear side 125 of the stair nosing 122 includes a tongue 135 and the front side 127 of the laminate stair tread 114 may include a groove 137 adapted to receive the tongue 135 therein. The laminate stair tread 114 is secured to the stair nosing 122 by the tongue 135 and groove 137 interlock mechanism, while the riser 116 is secured against the riser subflooring 120. The various components of the stair system 110 are generally held together using adhesive and nails, according to construction code requirements.

Referring now to FIG. 2, there is shown an alternative laminate stair tread commonly encountered in existing laminate flooring systems. The stair system 210 is similar to the laminate stair system 110 of FIG. 1, except that the stair nosing 222 has an upper flange 223 which covers the front side 227 of the laminate stair tread 214.

It is desirable, however, to have a laminate stair nosing that sits flush with the upper surface of the laminate stair tread to avoid tripping, for example. Any significant discontinuity on the upper surface of the laminate stair tread can also less aesthetically pleasing.

One of the problems associated with the conventional stair systems described in FIGS. 1 and 2 is that due to the forces applied to the stair nosing 122 or 222 while ascending or descending the stairs, the stair nosing 122 or 222 can become dislodged. It is observed that as a person's foot exerts forces on the stair nosing 122 or 222, the stair nosing 122 or 222 tends to pivot about a fulcrum positioned at the top edge 117 or 217 of the riser 116 or 216, causing the rear side 125 or 225 of the stair nosing 122 or 222 to pivot upwardly and become disjointed from the laminate stair tread 114 or 214.

In order to overcome this problem, various techniques such as the tongue 135 and groove 137 as illustrated in FIG. 1, or the securing of the nosing 222 to the stringer 212 by nail 230 as shown in FIG. 2, have been proposed. However, this problem is further exacerbated by the natural property of the wood product to expand and contract due to variations in temperature and humidity, as well as the loosening of the adhesive bond between the stair nosing 122 or 222 and the stringer 112 or 212, by reason of the relative movement of the stair nosing 122 or 222 against the top edge 117 or 217 of the riser 116 or 216 due to forces exerted while ascending or descending the stairs. Accordingly, irrespective of the proposed solutions, the stair nosing 122 or 222 can loosen and eventually become dislodged upon exertion of a large force, or numerous loading cycles.

Furthermore, it is desirable both for aesthetics and safety reasons to make the joint between the stair nosing 122 and the laminate floor 114 as seamless as possible. This requires fashioning the laminate stair tread 114 to ensure that the front side 127 of the laminate stair tread 114 perfectly mates with the rear side 125 of the stair nosing 122. The shaping of these components so that they evenly mate is difficult because the laminate stair tread 114 is fabricated from different materials than the stair nosing 122. Although the overlapping flange 223 in FIG. 2 seeks to solve this problem, the flange 223 may not meet the building code requirements of many municipalities as it is hazardous and may cause a person to trip while descending the stairs.

Lastly, since the nosing 122 or 222 is not made from the same material as the laminate stair tread 114 or 214, the colors may not match. The nosing 122 or 222 being generally made from solid wood is more expensive and is manufactured separately using different techniques than the fabrication of the laminate stair treads 114 or 214.

There is therefore a need in the industry to provide a laminate stair tread that obviates the foregoing problems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a laminate stair tread and method therefor. In accordance with one aspect of the present invention there is provided a laminate stair tread for a stair system, the laminate stair tread having a core having a top surface and a bottom surface, and opposing read side and front side, the front side being substantially curved, and a laminate layer affixed to the top surface of the core.

In accordance with another aspect of the present invention there is provided a method for installing a laminate stair system having laminate stair treads having a core having a top surface and a bottom surface, and opposing read side and front side, the front side being substantially curved, and a laminate layer affixed to the top surface of the core, the method comprising the steps of: (a) Measuring the width of the stair between the outmost stringers; (b) Cutting a piece of laminate stair tread to fit flush with the top of the existing stair tread; (c) Gluing the laminate stair tread in place over the tread subflooring by applying a bead of construction adhesive on a top surface of the tread subflooring and pressing the laminate stair tread thereto; (d) Cutting a piece of laminate riser at the same length as that of the stair laminate tread and at a width corresponding to the distance between the bottom laminate tread and the second laminate tread including the groove; and (e) Slidably inserting the riser into the groove.

In accordance with another aspect of the present invention there is provided a method for manufacturing a laminate stair tread having a core having a top surface and a bottom surface, and opposing read side and front side, the front side being substantially curved, and a laminate layer affixed to the top surface of the core, the method comprising the steps of: (a) Shaping a side of a core made of HDF into a curved shape for a stair nosing; (b) Applying a layer of glue is to the top surface and the curved side of the core; (c) Heating the core to temperature in the range of 200 to 220 degrees Celsius; (d) Placing a layer of laminate of a substantially the same area as the core on the top surface of the core; (e) Pressing the laminate against the top surface; (f) Bending the laminate against the curved side; and (g) Pressing the laminate against the curved side.

In accordance with yet another aspect of the present invention there is provided a method for manufacturing a laminate stair tread having a core having a top surface and a bottom surface, and opposing read side and front side, the front side being substantially curved, and a laminate layer affixed to the top surface of the core, the method comprising the steps of: (a) Shaping a side of a core made of HDF into a curved shape for a stair nosing; (b) Applying a layer of glue is to the top surface and the curved side of the core; (c) Heating the core to temperature in the range of 200 to 220 degrees Celsius; (d) Placing a layer of laminate of a substantially the same area as the core on the top surface of the core excluding the curved side; (e) Pressing the laminate against the top surface; (f) Placing a layer of laminate of a substantially the same area as the curved side on the curved side; and (g) Pressing the laminate against the curved side.

### BRIEF DESCRIPTION OF THE FIGURES

A better understanding of these and other embodiments of the present invention can be obtained with reference to the following drawings which show by way of example embodiments of the present invention, in which:

FIG. 1 is a side view of a conventional stair system according to the prior art;

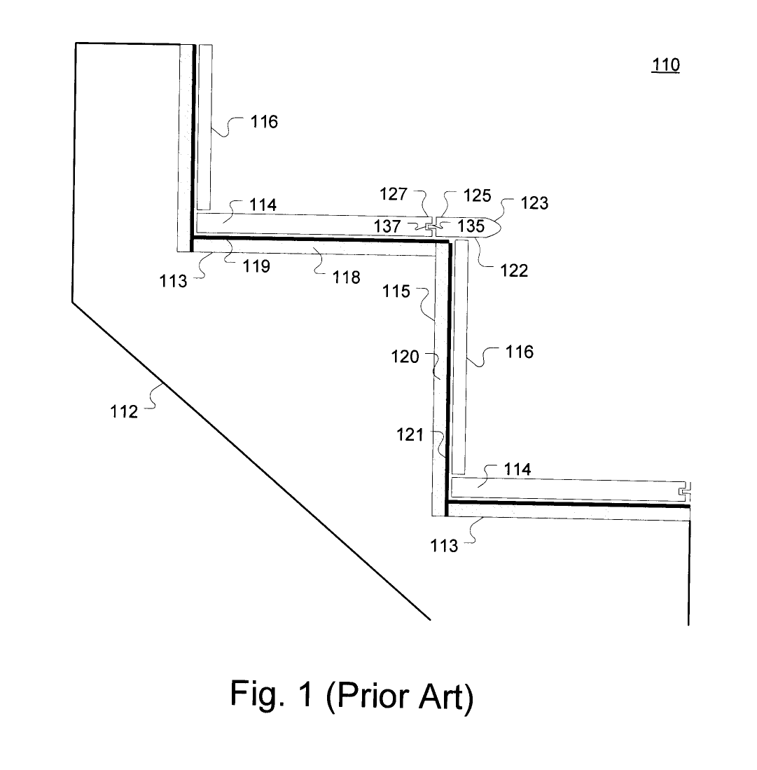

FIG. 2 is a side view of another conventional stair system according to the prior art;

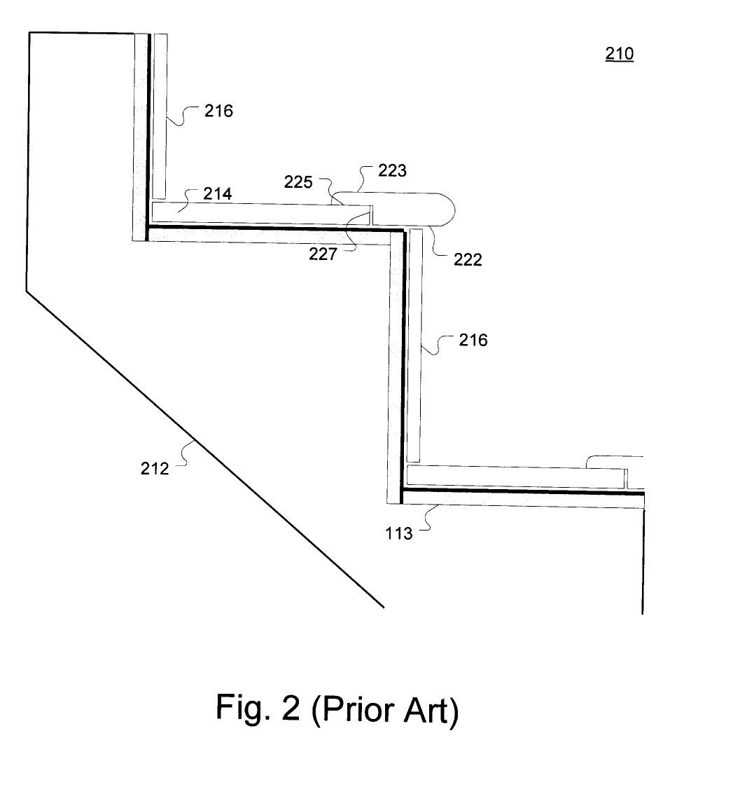

FIG. 3 is side view of a laminate stair system having a laminate stair tread according to an embodiment of the present invention;

FIG. 4 is side view of the laminate stair system whereby the laminate stair tread includes a groove to accommodate a stair riser according to one embodiment of the present invention;

FIG. 5 is a top view of the laminate stair tread illustrating an anti-slip feature of the laminate stair tread according to one embodiment of the present invention;

FIG. 6 is side view of a laminate stair system according to another embodiment of the present invention;

FIG. 7 is a flow chart showing the sequence of steps involved in the installation of the laminate stair tread according to one embodiment of the present invention;

FIG. 8 is a flow chart showing the sequence of steps involved in the manufacture of the laminate stair tread according to one embodiment of the present invention; and

FIG. 9 is a flow chart showing a sequence of steps involved in the manufacture of the laminate stair tread according to another embodiment of the present invention.

### DETAILED DESCRIPTION OF THE INVENTION

### Definitions

The term “high density fiberboard” (HDF) is used to define a high-density, moisture-resistant fiber panel manufactured from wood residues (such as sawdust, shavings and wood chips). This ligneous material is ground into a pulp to which a resin (such as melamine-urea-formaldehyde) is subsequently added. This pulp is then dried and pressed into panels of specific width and length. Optionally, the HDF may include an inner core such as a metal mesh or other form of reinforcement for improved rigidity.

The term “laminate” is used to define a thin layer of melamine impregnated decorative paper that is thermo-fused to the surface of the HDF and can be topped with an aluminum-oxide wear layer for improved scratch resistance and durability. A worker skilled in the art would readily understand alternate materials for laminate which can provide similar decorative and physical properties can be used.

The term “AC” is used to define a standardized measure of the hardness of the laminate adopted by The Association of European Producers of Laminate Flooring (ELPF). The AC rating defines the abrasion resistance, impact resistance, resistance to staining and cigarette burns, and thickness swelling along edges of a laminate floor covering. The AC rating is immediately followed by a number designating the actual AC ratings on a scale of 1 to 5. Typically, an AC1 is employed for areas with less frequent travel, such as a bedroom. The AC3 rating is suitable for residential use as well as low traffic commercial applications. The AC5 rating is more durable can withstand the traffic of heavier commercial areas such as department stores and public buildings. Generally, the building codes require an AC3 rating or above for laminate stairs.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

Exemplary embodiments of the present invention are now described with reference to accompanying drawings, wherein like elements are designated by like reference numerals throughout the drawings.

The present invention arises from the realization that existing laminate stairs require attachment of a separate stair nosing made from hardwood or other resilient materials that typically overlaps with the stair tread. This configuration of a stair nosing, however, is susceptible to becoming dislodged due to forces applied on the nosing during ascending or descending the stairs. Furthermore the nosing can be made from a different material than that of the laminate stair and therefore may not match the color of the stair, thereby causing a discontinuity in the upper surface of the stair tread which is not esthetically pleasing and may obstruct a person's foot while descending. The present invention seeks to overcome these drawbacks by providing a monolithic laminate stair tread having an integrally formed curved end that serves as the stair nosing, thereby producing a continuous substantially seamless surface. Furthermore, the structural rigidity of the monolithic laminate stair tread of the present invention can provide improved structural integrity when compared with multi-element stair tread and nosing combinations currently used.

### Laminate Stair Tread

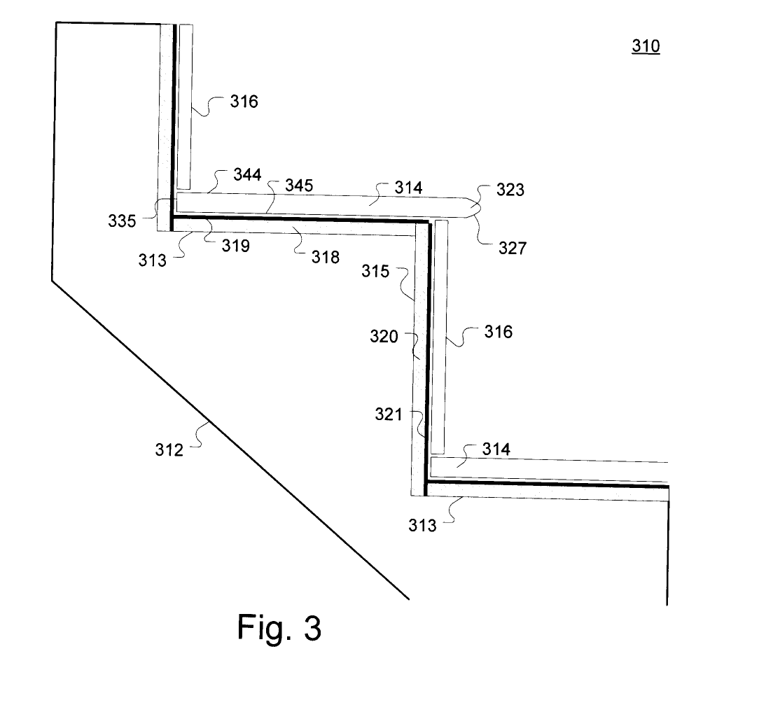

Reference is made to FIG. 3, which illustrates a stair system using laminate stair treads in accordance with an embodiment of the present invention. It is noted that although the measurements and dimensions provided herein are in respect of embodiments of the invention, the present invention is not limited to the dimensions provided and can be put into practice by those skilled in the art in accordance with for example, material strength requirements and building code requirements and dimensions.

As shown in FIG. 3, the stair system 310 includes stringers 312 to support the stairs. Although the stringers 312 are generally placed at the respective ends of the stairs, there may be intermediary stringers 312 depending on the length or width of the stairs and the degree of vertical support required. Each stringer 312 includes a stair tread-supporting side 313 which serves to provide structural support for a plurality of laminate stair treads 314. A stringer 312 also includes a riser-supporting side 315 for supporting the risers 316.

Although most stair systems today are constructed with subflooring, tread subflooring 318 may be attached onto the tread-supporting sides 313 to provide additional support for the laminate stair treads 314. Depending on the application, the tread subflooring 318 may be a plywood board, or particle-based products such as particleboard, waferboard, oriented-strand board or composite lumber. In applications where the stair supporting structure is made of concrete, subflooring 318 is generally used in conjunction with a layer of vapour barrier 319 sandwiched between the tread subflooring 318 and the laminate stair treads 314. The vapour barrier 319 can serve to protect the laminate stair treads 314 from moisture transfer from tread-supporting side 313. Alternatively, where tread subflooring 318 is supported by solid stairs such as a concrete stair support (not shown), the layer of vapour barrier 319 may be placed between the tread subflooring 318 and the concrete stair.

Risers 316 are generally attached to riser-supporting side 315 of the stringers 312, or in the alternative, attached to riser subflooring 320 affixed to the riser-supporting sides 315, with an optional layer of vapor barrier 312 placed in between the riser subfloorings 320 and the risers 316. In one embodiment, the risers 316 and the laminate stair treads 314 can have the same color and design to provide consistent stair pattern.

In one embodiment, the laminate stair tread 314 is made from HDF which includes a flat upper surface 344 and a lower surface 345. The upper surface 344 includes a layer of laminate with about an AC3 or AC4 rating to withstand the wear-and-tear caused by persons ascending or descending the stairs. The laminate stair treads 314 are fabricated by sawing a larger HDF board in the desired dimensions. The dimensions of the HDF board are application specific and are typically predicated by the specifications provided by the municipalities or national building codes. In the presently described embodiment of the invention, the laminate stair tread 314 is about 0.3 meter in width, about 1.2 meters in length, and has a thickness of about 12 millimeters to 20 millimeters.

. The laminate stair tread 314 is fabricated from HDF of about 18 mm in thickness. It has been observed that this thickness provides sufficient structural support for the laminate stair tread 314.

Alternate materials can be used to manufacture the laminate stair treads and risers as would be readily understood by a worker skilled in the art.

The laminate stair tread 314 also includes a front side 327 having a curved surface 323, and a rear side 335. Accordingly, the curved surface 323 acts as the stair nosing for the laminate stair tread 314, providing a monolithic laminate stair tread that obviates the need for a separate stair nosing. Moreover, the laminate stair tread 314 of the present invention provides a stair tread having a smooth surface that is free of any interruptions. Advantageously, the laminate surface of the laminate stair tread 314 is scratch-resistant and fade resistant so as to maintain its look regardless of the traffic.

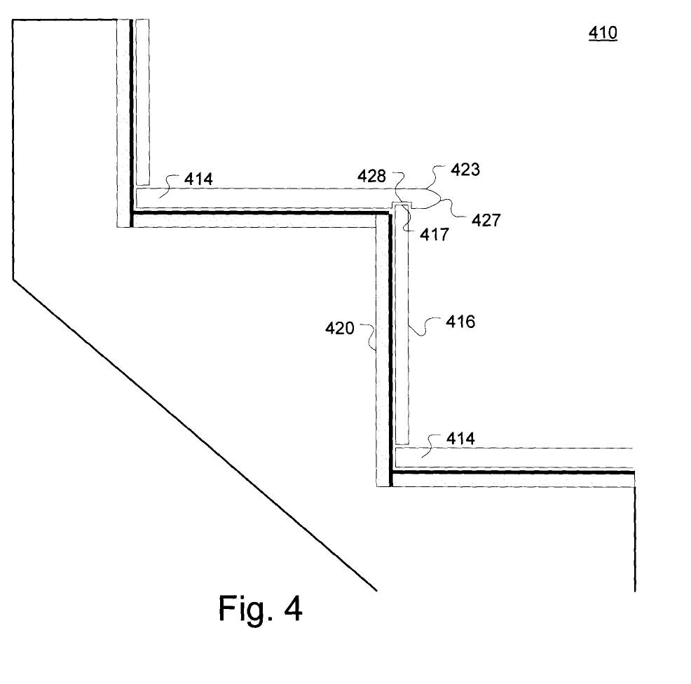

As further illustrated in FIG. 4, the front side 427 of the laminate stair tread 414 according to another embodiment of the present invention. As illustrated, the laminate stair tread 414 includes a groove 428 to accommodate therein the top edge 417 of the riser 416 in a sliding arrangement. Accordingly, the riser 416 is slidably secured in the front side 427 of the laminate stair tread 414 against the riser subflooring 420. In an alternative embodiment of the present invention, the width of the groove 428 is substantially larger than a width of the riser 416 for ease of installation.

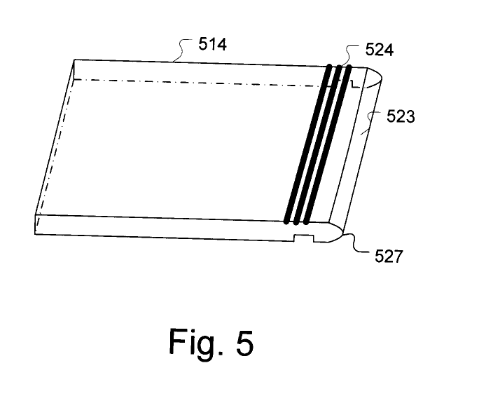

In addition to the usual function of step edge protection, the curved surface 323 or 423 renders the front side 327 or 427 of the laminate stair tread 314 or 414 less sharp, therefore less susceptible to scuffs and scratches, and more comfortable while descending. Advantageously, as further illustrated in FIG. 5, the curved surface 523 may include a slip-resistant feature such as a layer of abrasive non-slip material 524 made from a corrugated strip of metal, rubber, or the like that is deposited longitudinally along a length of the front side 527 to increase grip and improve stability at the front side 527 of the laminate stair tread 514. In an alternative embodiment of the present invention, the laminate stair tread 314 includes grooves along a length of the front side 527. These grooves may be formed prior to the laminate being adhered to the upper surface of the laminate stair tread 314.

In an alternative embodiment of the present invention, the surface of the front side 527 may be shaped to be corrugated along a length thereof for improved slip-resistance. Optionally, the non-slip material 524 may be photoluminescent to provide a clearer and safer indication of the stair edge in power failure or darkness induced situations. Furthermore, the non-slip material 524 may be shaped so as to follow the contours of the curved surface 523 and to substantially cover the front side 527.

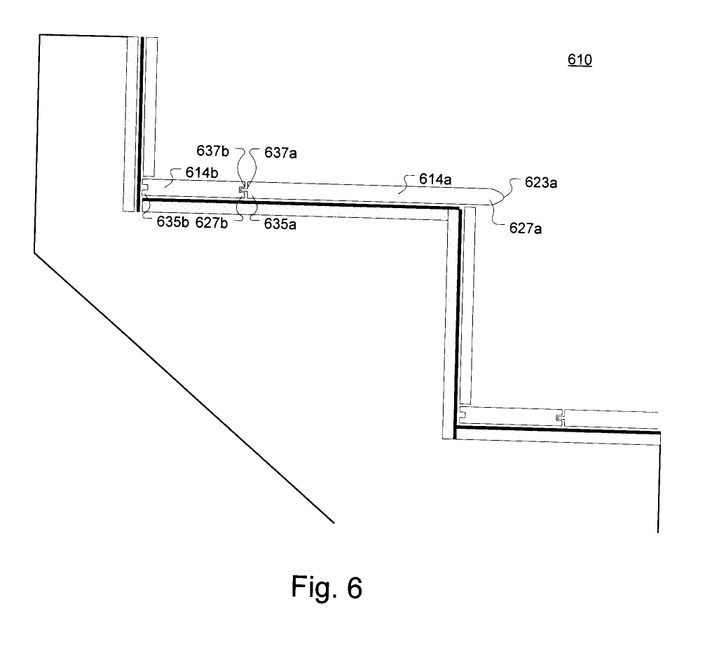

Referring to FIG. 6, a laminate stair tread according to another embodiment of the present invention is shown. The laminate stair system 610 is particularly useful for a stair landing. The laminate stair system 610 has a first laminate stair tread 614a and a second laminate stair tread 614b. The first laminate stair tread 614a has a front side 627a having a curved surface 623a, and a rear side 635a. The second laminate stair tread 414b includes a substantially flat front side 627a and a rear side 635b. The rear side 635a of the first laminate stair tread 414a includes a tongue 637a, and the front side 627b of the laminate stair tread 614b has a groove 637b that is adapted to mate with the tongue 637a to form an interlock connection. As a result, the laminate stair tread 614a can be coupled to the laminate stair tread 614b that is adaptable to provide stair covering for areas such as stair landings. Optionally, the tongue 627a and groove 627b can be the UNICLIC™ tongue-and-groove mechanism or other locking mechanisms for laminate flooring systems as known to those skilled in the art. In an alternative embodiment, the front sides 627a and 627b and the rear sides 635a and 635b are microbeveled. In an alternate embodiment, the rear side 635a of the first laminate stair tread 414a includes a groove, and the front side 627b of the laminate stair tread 614b has a tongue that is adapted to mate with the groove to form an interlock connection.

### Method of Installation

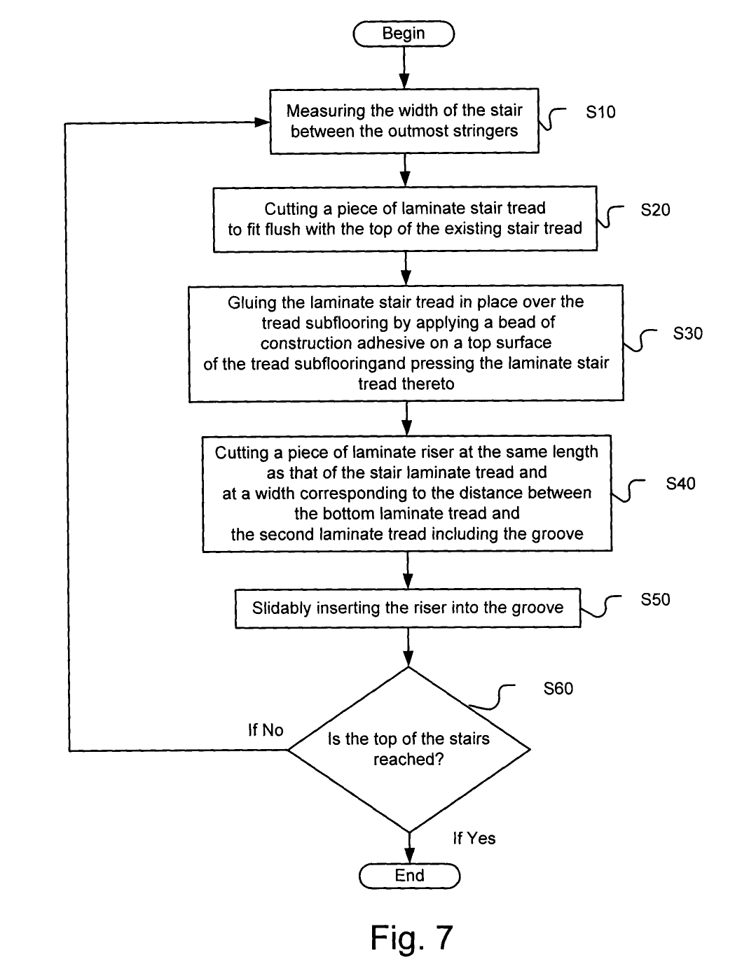

FIG. 7 illustrates a flow chart showing the sequence of steps according to one embodiment of the present invention, involved in the installation of the laminate stair tread 310 illustrated in FIG. 3. Beginning at the bottom riser 316, the first step involves measuring the width of the stair between the outmost stringers 312 (S10). Since the laminate stair tread 314 is typically fabricated from a HDF core about 8 feet in length, it must be cut into a piece of laminate stair tread 314 to fit flush with the top of the existing stair tread (S20). The laminate stair tread 314 is then glued in place over the tread subflooring 318 by applying a bead of construction adhesive on a top surface of the tread subflooring 318 and pressing the laminate stair tread 314 thereto (S30). Subsequently, the stair riser 316 is installed by cutting a piece of laminate riser 316 at the same length as that of the stair laminate tread 314 and at a width corresponding to the distance between the bottom laminate tread 314 and the second laminate tread 314 including the groove 328 (S40). Then the riser 316 is slidably inserted into the groove 328 (S50). These steps are repeated for the subsequent stairs until the top of the stairs is reached (S60) and wherein the installation of the stair system therefore completed.

### Method of Manufacture

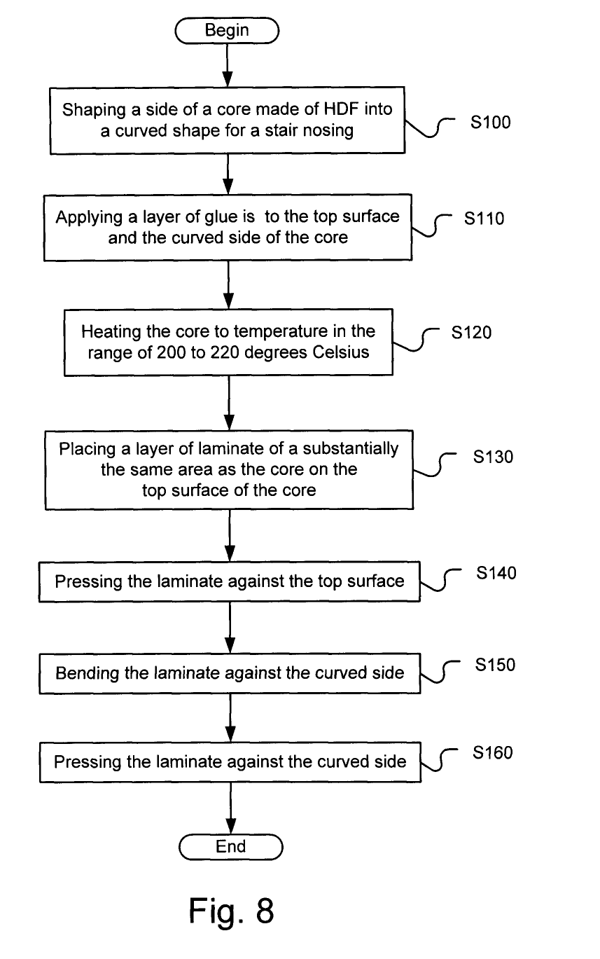

Referring now to FIG. 8, there is show the steps involved in the manufacture of a laminate stair tread according to one embodiment of the present invention. The first step involves shaping a side of a core made of HDF into a required shape for a stair nosing, which is generally a curved, domed-shaped configuration (S100). The curved side will serve as the nosing for the laminate stair tread. A layer of glue is subsequently applied to the top surface and the curved side of the core (S110). The core is then heated to a temperature in the range of about 200 to about 220 degrees Celsius (S120). A layer of laminate of a substantially the same area as the core is then placed on the top surface of the core (S130), and pressed against the top surface (S140) while bending the laminate proximate to the curved side (S150) and pressing it against the curved side (S160) so as to obtain a layer of laminate uniformly applied to the top side and the curved side.

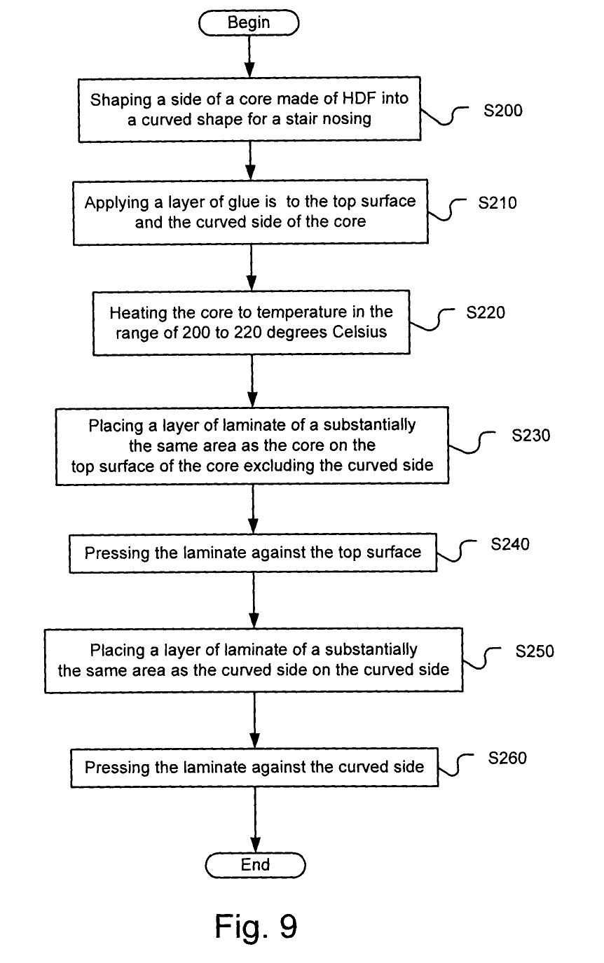

Referring to FIG. 9, there is shown a series of steps for the manufacture of a laminate stair tread according to another embodiment of the present invention. First, a side of a HDF core is shaped into a curved configuration (S200). A layer of glue is then applied to the top surface and the curved side of the core (S210). The core is subsequently heated to a temperature in the range of about 200 to about 220 degrees Celsius (S220). A layer of laminate of having substantially the same area as the core excluding the curved side is placed on the top surface of the core (S230), and affixed thereto by pressing the laminate against the top surface (S240). A strip of laminate having substantially the same area as the curved side is placed against the curved side (S250) and pressed thereto (S260) to cover the curved area with laminate.

Although the steps involved in the manufacture of a laminate stair tread are described in reference with a laminate stair tread having a generally curved no sing, other nosing configurations can be contemplated by skilled artisans, depending on the application. It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

What is claimed is:

1. A laminate stair tread comprising: a core having a top surface and a bottom surface, and opposing read side and front side, the front side being substantially curved, and a laminate layer affixed to the top surface of the core.

2. A laminate stair tread as set forth in claim 1, the laminate stair tread having a first member having parallel first and second longitudinal sides, and comprising a tongue formed along the first longitudinal side, and the second side being substantially curved.

3. A laminate stair tread as set forth in claim 2, further comprising a second member having parallel first and second longitudinal edges, and comprising: grooves formed along the first and second longitudinal sides, whereby the grooves are configured to mate interlockingly with the complementary shaped tongue formed along the first longitudinal side of the first member.

4. A laminate stair tread as set forth in claim 1, wherein the core is made from high density fiberboard.

5. A laminate stair tread as set forth in claim 1, wherein the core has a thickness of about 12 millimeters to 20 millimeters.

6. A method for installing a laminate stair system having laminate stair treads having a core having a top surface and a bottom surface, and opposing read side and front side, the front side being substantially curved, and a laminate layer affixed to the top surface of the core, the method comprising the steps of:
(a) Measuring the width of the stair between the outmost stringers;
(b) Cutting a piece of laminate stair tread to fit flush with the top of the existing stair tread;
(c) Gluing the laminate stair tread in place over the tread subflooring by applying a bead of construction adhesive on a top surface of the tread subflooring and pressing the laminate stair tread thereto;
(d) Cutting a piece of laminate riser at the same length as that of the stair laminate tread and at a width corresponding to the distance between the bottom laminate tread and the second laminate tread including the groove; and
(e) Slidably inserting the riser into the groove.

7. A method for manufacturing a laminate stair tread having a core having a top surface and a bottom surface, and opposing read side and front side, the front side being substantially curved, and a laminate layer affixed to the top surface of the core, the method comprising the steps of:
(a) Shaping a side of a core made of HDF into a curved shape for a stair nosing;
(b) Applying a layer of glue is to the top surface and the curved side of the core;
(c) Heating the core to temperature in the range of about 200 to 220 degrees Celsius;
(d) Placing a layer of laminate of a substantially the same area as the core on the top surface of the core;
(e) Pressing the laminate against the top surface;
(f) Bending the laminate against the curved side; and
(g) Pressing the laminate against the curved side.

8. A method for manufacturing a laminate stair tread having a core having a top surface and a bottom surface, and opposing read side and front side, the front side being substantially curved, and a laminate layer affixed to the top surface of the core, the method comprising the steps of:
(a) Shaping a side of a core made of HDF into a curved shape for a stair nosing;
(b) Applying a layer of glue is to the top surface and the curved side of the core;
(c) Heating the core to temperature in the range of about 200 to 220 degrees Celsius;
(d) Placing a layer of laminate of a substantially the same area as the core on the top surface of the core excluding the curved side;
(e) Pressing the laminate against the top surface;
(f) Placing a layer of laminate of a substantially the same area as the curved side on the curved side; and
(g) Pressing the laminate against the curved side.
